(19) United States
(12) Patent Application Publication
(10) Pub. No.: US 2010/0299169 A1
(43) Pub. Date: Nov. 25, 2010

(54) Planning Device and Method for Planning a Technical Installation

(76) Inventors: Michael Schlereth, Wilhermsdorf (DE); Thilo Stolper, Nurnberg (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/863,573

(22) PCT Filed: Jan. 18, 2008
(86) PCT No.: PCT/EP08/00386

§ 371 Date: Jul. 19, 2010

(51) Int. Cl. G06Q 10/00

(52) U.S. Cl. 705/7

(57) ABSTRACT

A planning device for planning a technical installation comprising modules having mechanical components and electrical components, where every module has a desired functionality. In accordance with the invention, a library of sets of electrical components include the properties of the mechanical components and electrical components from which a component set can be allocated to a module by allocation function, and the properties of the allocated component set, which is defined in component parameters, is usable to determine whether the module functionality resulting from the allocated component set corresponds to the desired functionality with a definable accuracy.

### CROSS-REFERENCE TO RELATED APPLICATIONS

This is a U.S. national stage of International Application No. PCT/EP2008/000386, filed on 18 Jan. 2008.

### BACKGROUND OF THE INVENTION

1. Field of the Invention

The invention relates to planning devices and, more particularly, to a planning device for planning a technical installation, with the technical installation being formed from modules which each have mechanical and electrical components, and each module includes a desired functionality. The invention also relates to a corresponding method.

2. Description of the Invention

A method for an object-oriented plant design is described in the article “objektorientierte Fabrikplanung” [object-oriented plant design] by G. Schuh, Werkstatttechnik Online, volume 97 (2007), H.3. A comparison is made with software engineering. A hierarchical structure is proposed for the planning of a plant. Plant modules are configured in hierarchically consecutive planning stages from a rough schematic diagram to a fine, more detailed diagram. As in object-oriented programming, each module is embodied here in accordance with the principle of encapsulation such that the module can be easily replaced when the planning is changed. Interactions are only possible over interfaces which are made available explicitly.

The digital planning of technical installations is gaining increasing importance. Currently, virtual mapping of the technical installation allows investments to be protected at a very early stage by a simulation. In the case of production installations, product planning can be converted far more quickly into a finished product. Such digital planning requires a very large quantity of data. Aside from the purely digital mapping of the technical installation through geometry in the form of a 3D simulation, attempts are increasingly also being made to simulate the technical functionalities of the installation in the form of a virtual commissioning. Aside from the geometric and mechanical properties of the components of the technical installation, more and more electrical properties are thus also being included. In the case of a production installation, aside from the geometric properties of a manufacturing robot and the dimensions of a manufacturing cell for instance, properties of an electric motor for instance, such as electrical output power or torque, are also taken into account. All components generally interact with one another. To assess the suitability of a component for the task at hand, further components must already be selected to determine, by a simulation, whether the desired result will be achieved. The large variety of possible combinations thus resulting has led to a large planning outlay when determining an optimal configuration.

### SUMMARY OF THE INVENTION

It is therefore an object of the invention to provide a planning device with which a technical installation can be planned with particularly minimal planning outlay. A further object of the invention is to specify a corresponding planning method.

This and other objects and advantages are achieved in accordance with the invention by providing a planning device for planning a technical installation. Here, the technical installation is formed from modules which each include mechanical and electrical components, where each module includes a desired functionality and a library of sets of electrical components that is provided with properties of these components. In accordance with the invention, a component set can be allocated to a module by an allocation function and the properties of this component set defined in component parameters can be used to deduce whether the module functionality resulting with from the component set corresponds to the desired functionality with a definable accuracy.

The invention is based on the knowledge that eligible electrical components can be grouped together, such as in a manufacturer-oriented grouping. Electrical components from one manufacturer generally exhibit a better compatibility with respect to one another than electrical components from different manufacturers. Furthermore, technical installations often have specifications relating to the choice of manufacturer for the electrical components. A further grouping option can exist in terms of the functionality. For instance, electrical components could be grouped based on their safety level.

A marked simplification of the planning process is now achieved by grouping the electrical components into a component set. The functionality of a module is described by a desired functionality. An entire component set is now used to realize this desired functionality. Here, a component set can, to some extent, be understood as a collection in the style of a clothing collection. Trying the collection on in a fitting room corresponds to a comparison of the functionality resulting from the collection with the desired functionality. The selection options of a planner are therefore restricted by the component set, thereby resulting on the one hand in a clear simplification of the planning process and on the other hand, when using proven collections, in other words component sets, also in a quality benefit. Component sets are stored in a library. Compared with previous planning approaches which, if need be, permitted a selection of individual electrical components from a collection of different components of the same type, different types of components are now grouped with one another to form a component set. As a result, the selection of a component set during the planning creates a series of components of a different functionality being determined. Here, the components of a component set are compatible with one another. A component set therefore already has an internal compatibility. The component set is preferably further developed over time such that its functionality corresponds with the desired functionality of as large a number of modules as possible.

The check for correspondence preferably occurs by simulating the module functionalities, with the component parameters underlying the simulation. A digital planning of a technical installation can be performed by simulating the processes on the technical installation. Such a simulation can determine whether the components used actually provide the desired functionality. For instance, the result of a real-time simulation could be that the components used do not lead to the method being processed at the desired speed. Here, the component set cannot therefore be used unchanged.

The check for correspondence is preferably performed by comparing the desired parameters that characterize the desired functionality with corresponding component parameters of the component set. The desired functionality is therefore mapped by parameters. A component set is described by parameters, which correspond at least partially in their type to the parameters of the desired functionality. If the parameters of the component set also correspond in terms of their value to the parameters of the desired functionality, and/or they are within a corresponding interval, the desired correspondence is present.

The electrical components are preferably implemented mechatronically with an additional mechanical functionality. Electrical and mechanical elements of a component are increasingly merged to form an integrated structure. For instance, piezoelectric modules can fulfill mechanical tasks. The integrated embodiment of a gripper arm together with its electrical drive may also be a mechatronic component. The use of mechatronic components results in a further simplification of the planning process.

The planning can preferably be implemented by a planning process which is structured in hierarchical levels and has consecutive planning stages, with the mechanical or electrical components of a lower planning stage of the at least second hierarchical level having the properties of the mechanical or electrical components of the upper planning stage from the hierarchical level arranged upstream of the lower planning stage and also a higher level of detail with respect to the properties of the mechanical or electrical components. Furthermore, the planning apparatus preferably comprises an object-oriented architecture, so that within the meaning of the rules of the object-oriented programming, a planning stage is described by classes, the objects with properties of the mechanical and electrical components as attributes and methods instantiate the module functionalities, and where a lower planning stage inheriting attributes and methods of the upper planning stage.

A greater degree of detail can be gradually set in consecutive planning stages by a planning process which is divided into hierarchical levels. An inheritance of properties allows planning of a preceding planning stage to easily be specified in greater detail. By a detailing now being available from a library by selecting a component set, the planning of a planning stage can be implemented particularly efficiently with a high degree of detail. Within the meaning of object-oriented programming, a component set is available as a set of classes.

The planning apparatus preferably comprises a visualization apparatus, in which graphical images of the modules can be shown, with the degree of detail of the graphical display increasing downwards hierarchically along the planning stages and with the lower planning stage being displayed by superimposing graphical elements from this lower planning stage over the elements of their upper planning stage. During the planning of a technical installation, a visualization is needed, which is generally undertaken by a 2D or 3D display on the computer. An increased level of detail of a planning stage is now expediently achieved by superimposing its elements over the abstract elements of the preceding planning stage. The use of whole component sets becomes clear in this visualization by a specific collection being wrapped like an envelope around the more abstract display. A deviation of the functionality produced by the selected collection, i.e. of the component set, from the desired functionality can be made visible by graphical displays. For instance, components of the component set which cause the deviation from the desired functionality can be shown flashing or in another color.

The technical installation is preferably a production line for manufacturing a product. The digital planning of a plant for producing a product is already reality in many areas. The planning of such a production line entails the highest complexity. The selection of the electrical components, in particular of automation components, is generally subject to boundary conditions of the plant developer and/or operator. In particular, a manufacturer-specific selection is often taken into consideration.

In another object a method is achieved in accordance with the invention by providing a method for planning a technical installation, in which the technical installation is formed from modules which each have mechanical and electrical components, with each module having a desired functionality and with a library of sets of electrical components being provided with properties of these components, from which a component set can be allocated to a module by an allocation function and the properties of the component set defined in component parameters can be used to deduce whether the module functionality resulting from the component set corresponds to the desired functionality with a definable accuracy.

The advantages of such a method emerge from the details given above relating to the advantages of the planning device.

The check for correspondence preferably occurs by comparing desired parameters that characterize the desired functionality with the component parameters.

The check for correspondence preferably occurs by simulating the module functionality using the parameters of the component set underlying the simulation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in more detail with reference to the drawings, in which:

FIG. 1 is an illustration of a technical installation;

FIG. 2 shows a module of a technical installation of FIG. 1;

FIG. 3 is an illustration of a planning device and a component set in accordance with an embodiment of the invention;

FIG. 4 is an illustration of a method for planning a technical installation in accordance with an embodiment of the invention; and

FIGS. 5a-5c are illustrations of a visualization device in accordance of the invention.

### DETAILED DESCRIPTION OF THE PREFERRED EMBODIMENTS

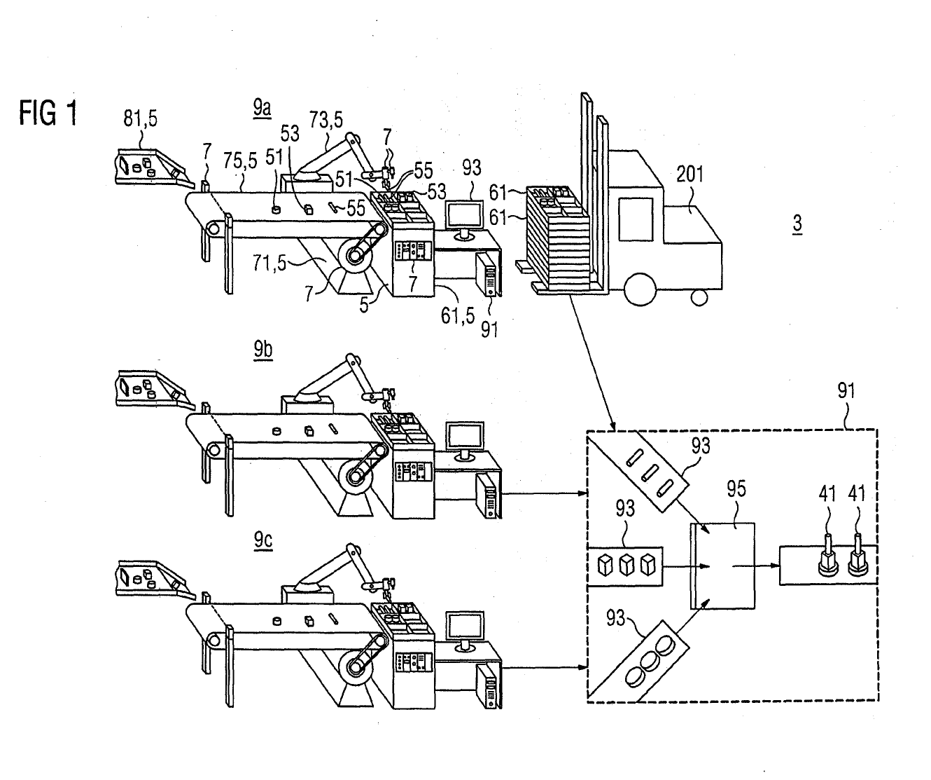

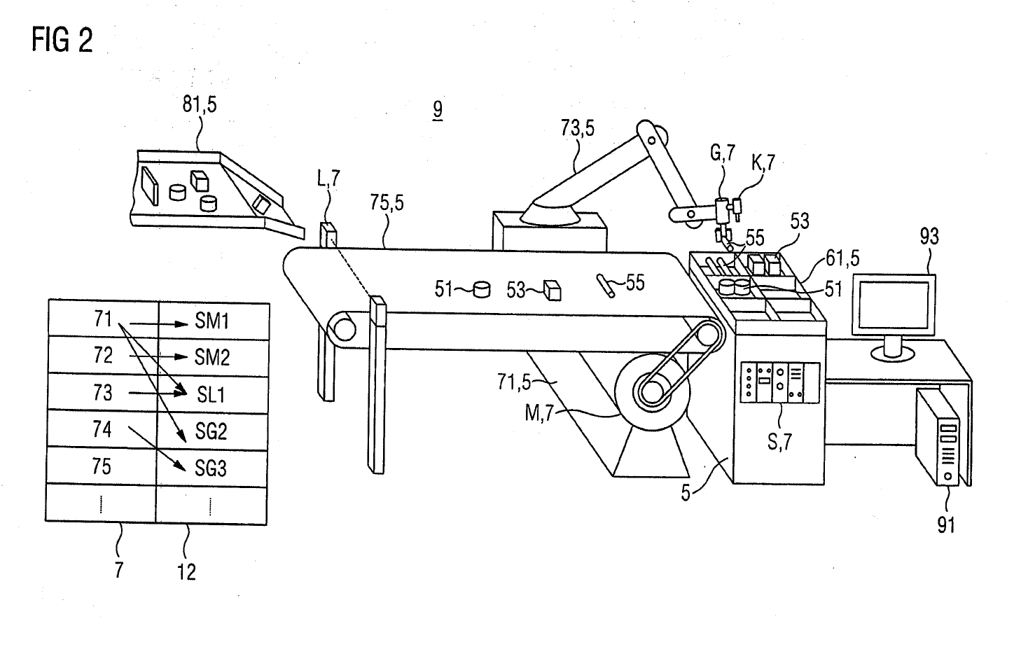

FIG. 1 shows a technical installation 3. The technical installation 3 has three modules 9a, 9b, 9c. The modules 9 are explained in more detail in FIG. 2. The technical installation 3 is embodied here as a manufacturing plant. The modules 9 sort manufacturing parts. The manufacturing parts are transported in pallets 61 by way of a fork lift truck 201 to a further manufacturing section 91. The manufacturing parts are combined at the further manufacturing section 91 by conveyor belts 93 in an assembly unit 95 to form a product 41. The planning of such a technical installation 3 requires a very accurate description of the properties and functions of all the components used. In more complex technical installations, this quickly results in a very complicated planning process. How this planning process can be more simply configured is described in more detail below.

FIG. 2 shows one of the modules 9 of the technical installation 3 of FIG. 1. The module 9 has a robot 73 with a gripper G. A camera K is installed on the gripper G for purposes of pattern recognition. The robot 73 is installed in front of a belt conveyor 75. The belt conveyor 75 has a motor M for its drive, when the motor is being placed on a base 71. The robot 73, the belt conveyor 75 and the base 71 are mechanical components 5 of the module 9. The gripper G, the camera K and the motor M are electrical components 7 of the module 9. The gripper G is embodied here as a mechatronic component. Aside from electrical components for its drive, the gripper G also has mechanical components for gripping. A further electrical component is a programmable logic controller S. This controller S is used to control the process of the production flow on the module 9. A computer 91 and a screen 93 allow intervention into the procedure and parameters to be set for it. Product parts 51, 53, 55 of different geometries are transported by the belt conveyor 75 to the robot 73 by a feeder track 81. The product parts 51, 53, 55 pass a proximity sensor which comprises a light beam in the process. The robot 73 identifies, by the camera K, the different geometries of the product parts 51, 53, 55. Depending on the geometry, the robot 73 uses the gripper G to sort the product parts 51, 53, 55 into a pallet.

The desired functionality of the module 9 is described in parameters F. For instance, a parameter F1 specifies a desired flow rate. This results in a specification relating to a quantity of desired parameters 12 for the electrical components 7, e.g., for a parameter SM1 of the motor M but also relating to a parameter SL1 for a resolution of the light barrier L or a parameter SG2 of the gripping speed of the gripper G. Other parameters F of the desired functionality of the module 9 thus also determine parameters of the electrical component 7.

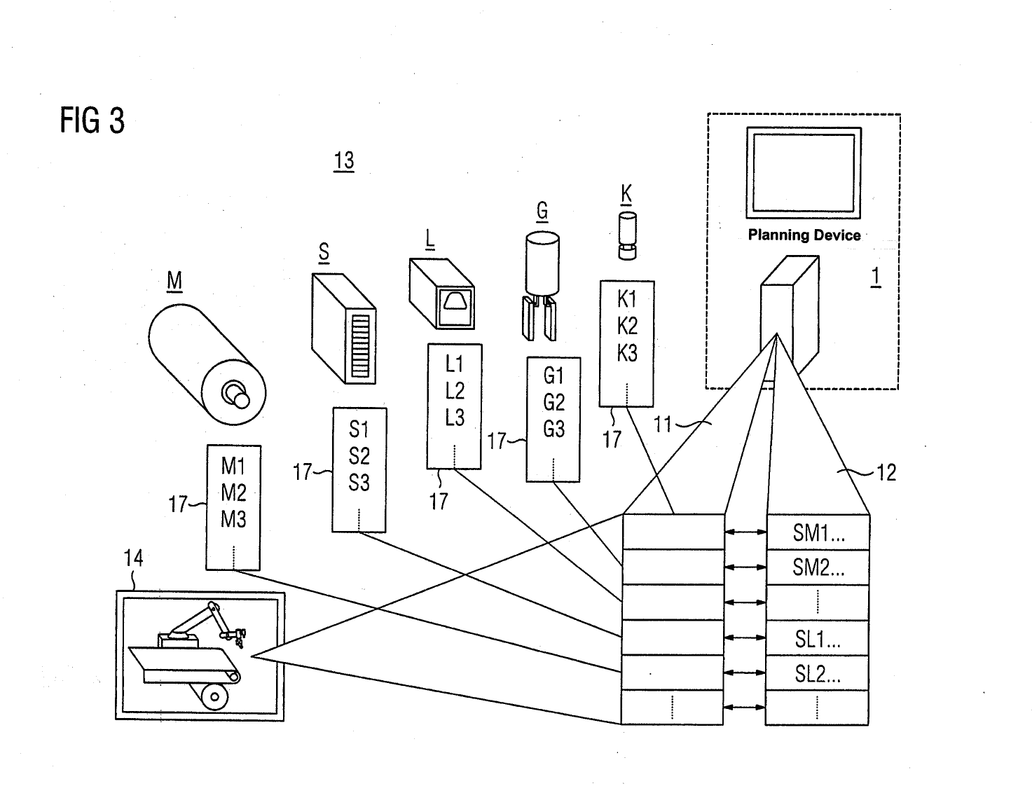

FIG. 3 shows a component set 13. The component set 13 includes a motor M, a controller S, a light barrier L, a gripper G and a camera K. Each of these electrical components 7 has a component parameter set 17. The component set 13 is stored together with further component sets in a library 11 of a planning device 1. The desired parameters 12 are likewise available to the planning device 1, where the desired parameters 12, as described above, describe the desired functionality of the module 9. By comparing the component parameters 17 of the component set 13 with the desired parameters 12, a check is performed to determine whether the desired functionality of the module 9 can be implemented by the component set 13. A further possibility for this check provides for a simulation of the production flow on the module 9. To this end, the production flow of the module 9 is simulated by a simulation apparatus 14, which is created based on the component set 13 that is used. If the simulation produces a satisfactory production flow, the check is successful.

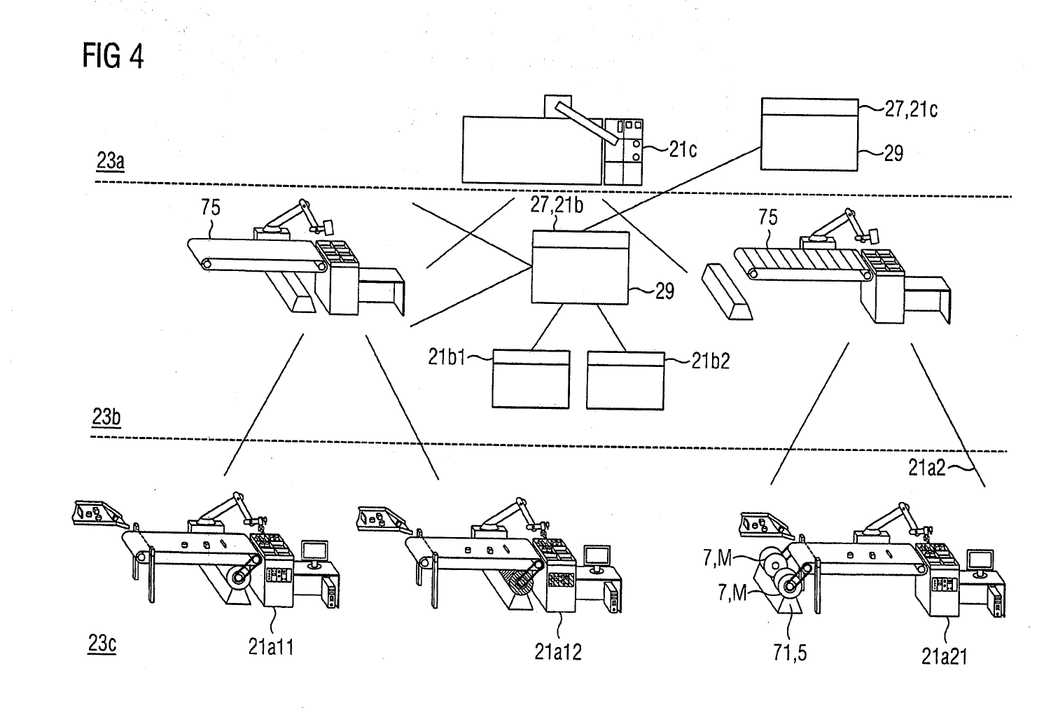

FIG. 4 shows a method for planning a technical installation 3. A planning process is divided into hierarchical levels 23. A first planning stage 21c is implemented in a first hierarchical level 23a. In this planning stage, only a rough schematic display occurs in 2D form for the module 9. In a next planning stage 21b of the second hierarchical level 23b, the module 9 is presented in greater detail. Here the belt conveyor 75 can comprise a first variant 21b1 as a conveyor belt. In a second variant 21b2, the belt conveyor 75 is embodied as a chain belt conveyor. These two variants define different configurations for the electrical components. The configuration of the electrical components occurs in hierarchical level 23c with the planning stage 21a. Here, different variants can again arise. A first variant 21a11 arises with a first component set 13. A second variant 21a12 arises with a second component set 13. By simulating the production flow on the module 9, a check is performed in both variants to determine, whether the desired functionality of the module 9 is reached. Different possible variants likewise ensue from the second variant of the second planning stage 21b. Here, component sets for chain conveyors are considered from the library 11. Chain conveyors differ from the belt conveyor, for instance, in the number of their drives.

This planning process is expediently implemented in an object-oriented architecture. A class 27 is allocated to a hierarchical level in each instance. The class 27 instantiates objects 29. A subordinate hierarchical level 23b inherits the attributes and methods of the preceding hierarchical level 23a, in other words the classes 27 of a subordinate hierarchical level 23b inherit the attributes and methods of the classes 27 of the upstream hierarchical level 23a.

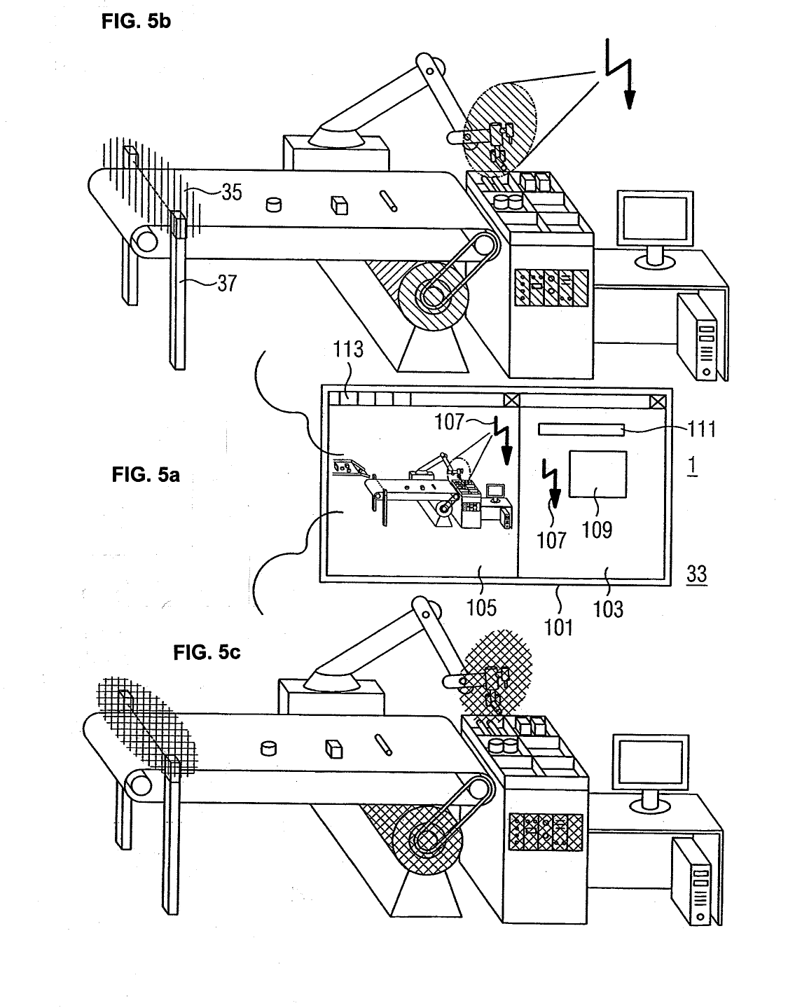

FIG. 5a shows a visualization device 33 of a planning device 1. A first window 103 and a second window 105 are shown on a graphical user interface 101. The technical installation 3 is shown graphically in the second window 105. A specific component set for a module of the technical installation is selected in the first window 103 by an input dialog 111. A simulation of the production flow of the technical installation with the selected component set is implemented by a menu 113. If a deviation of the simulated functionality from the predetermined desired functionality is determined, an error message 107 is generated. An error description 109 for the error message 107 is output in the first window 103. FIG. 5b shows how a first component set is indicated by a first cross-hatched area differing from another cross-hatched area of another component record in FIG. 5c. Whereas the desired functionality is achieved with the component set from FIG. 5c, an error message results with the component set from FIG. 5b. Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

1.-12. (canceled)

13. A planning device for planning a technical installation having modules forming the technical installation, each module including mechanical and electrical components and having a desired functionality, the planning device comprising:
a library of sets of electrical components, each of the sets including the properties of the respective electrical components, and
an allocation function, a component set of the library of sets being allocateable to a module by the allocation function, the properties of the allocated component set defined in component parameters being utilizable to determine whether the module functionality resulting from said allocated component set corresponds to the desired functionality with a definable accuracy.

14. The planning device as claimed in claim 13, wherein the planning device checks for correspondence by comparing desired parameters, which characterize the desired functionality, with corresponding component parameters of the component set.

15. The planning device as claimed in claim 13, wherein the planning device checks for correspondence by simulating the module functionality with the component parameters underlying the simulation.

16. The planning device as claimed in claim 13, wherein the electrical components of the library of sets are implemented mechatronically with an additional mechanical functionality.

17. The planning device as claimed in claim 13, wherein the planning device implements a planning process which is structured in hierarchical levels and includes consecutive planning stages, one of the mechanical or electrical components of a lower planning stage of at least one second hierarchical level having the properties of the mechanical or electrical components of an upper planning stage from an hierarchical level upstream of a lower planning stage and having a higher level of detail of the properties of the mechanical or electrical components.

18. The planning device as claimed in claim 17, wherein the planning device has an object-oriented architecture such that a planning stage is described by classes within object-oriented programming rules, the objects instantiate with properties of the mechanical and electrical components as attributes and methods of module functionalities, and wherein the lower planning stage inherits attributes and methods of the upper planning stage.

19. The planning device as claimed in claim 17, further comprising:
a visualization device in which the modules are graphically displayable,
wherein a degree of detail of the graphical display increases hierarchically downwards along the consecutive planning stages, the lower planning stage being displayed by superimposing graphical elements from the lower planning stage over elements of the upper planning stage such that a schematic display of the upper planning stage is enriched by a greater richness of detail of the lower planning stage.

20. The planning device as claimed in claim 18, further comprising:
a visualization device in which the modules are graphically displayable,
wherein a degree of detail of the graphical display increases hierarchically downwards along the consecutive planning stages, the lower planning stage being displayed by superimposing graphical elements from the lower planning stage over elements of the upper planning stage such that a schematic display of the upper planning stage is enriched by a greater richness of detail of the lower planning stage.

21. The planning device as claimed in claim 13, wherein the technical installation comprises a production line for producing a product.

22. A method for planning a technical installation, comprising:
forming the technical installation from modules each having mechanical and electrical components and a desired functionality;
providing a library of sets of electrical components with properties of the respective electrical components;
allocating a component set from the library of the sets of the electrical components to a module by an allocation function; and
determining whether the module functionality resulting from said allocated component set corresponds to the desired functionality with a definable accuracy based on the properties of the allocated component set defined in component parameters.

23. The method as claimed in claim 21, wherein said step of determining whether the module functionality resulting from said allocated component set corresponds to the desired functionality with a definable accuracy comprises comparing desired parameters which characterize the desired functionality with the component parameters.

24. The method as claimed in claim 21, wherein said step of determining whether the module functionality resulting from said allocated component set corresponds to the desired functionality with a definable accuracy comprises comparing simulating the module functionality using parameters of the component set underlying the simulation.

25. The method as claimed in claim 21, further comprising creating a new component set if the component set does not correspond to the module functionality such that the correspondence occurs.

26. The method as claimed in claim 22, further comprising creating a new component set if the component set does not correspond to the module functionality such that the correspondence occurs.

27. The method as claimed in claim 23, further comprising creating a new component set if the component set does not correspond to the module functionality such that the correspondence occurs.
